(19) United States
(12) Patent Application Publication
(10) Pub. No.: US 2025/0081973 A1
(43) Pub. Date: Mar. 13, 2025

(54) METHODS OF MANUFACTURING SELF-RISING OAT BREAD AND OAT BREAD PRODUCTS PRODUCED BY THE METHODS

(71) Applicant: rND Foods Ltd., Smiths Falls (CA)

(72) Inventor: William John SPENCER, Smiths Falls (CA)

(73) Assignee: rND Foods Ltd., Smiths Falls, ON (CA)

(21) Appl. No.: 18/377,341

(22) Filed: Oct. 6, 2023

Related U.S. Application Data
(60) Provisional application No. 63/537,228, filed on Sep. 8, 2023.

(51) Int. Cl. A21D 13/047

(52) U.S. Cl. CPC A21D 13/047

(57) ABSTRACT

The present invention provides to a method of manufacturing a self-rising oat bread and bread products produced by the method.

### FIELD OF THE INVENTION

This invention pertains generally to bakery products and in particular, to methods of manufacturing a self-rising oat bread and bread products produced by the method.

### BACKGROUND OF THE INVENTION

Gluten is found in the endosperm of wheat and other cereals such as barley, rye and spelt. Oats are naturally gluten-free. Individuals suffering from celiac disease or gluten-intolerance must avoid gluten in their diet. Gluten-free bread products are available on the market. Such gluten-free products often have poor taste and texture.

In addition, many of the bread products on the market, including gluten free products, include yeast as a leavening agent. Yeast may cause digestive issues in individuals.

Accordingly, there is a need in the art for gluten free bread products that do not utilize yeast as a leavening agent.

### SUMMARY OF THE INVENTION

The present invention provides a method of manufacturing self-rising oat bread and oat bread products produced by the method. In one aspect of the present invention, there is provided a method of manufacturing one or more bread products, the method comprising: mixing oat flakes, hull-less oats, psyllium husks, salt and water to produce a dough; shaping the dough into one or more bread products; and baking the bread products.

In another aspect of the present invention, there is provided a method of manufacturing one or more self-rising oat bread products, the method comprising: mixing oat flakes, hull-less oats, psyllium husks and salt to produce a mixture of dry ingredients; adding water to the dry ingredients and mixing to produce a dough; shaping the dough into one or more bread products; and baking the bread products.

In certain embodiments of the method, the mixing of dry ingredients prior to addition of water is for about 5 minutes.

In certain embodiments of the method, the mixing of dry ingredients with water to produce a dough is for about 12 minutes.

In certain embodiments, the baking is at about 210° C.

In another aspect of the present invention, there is provided a bread product produced by the methods of the invention.

In another aspect of the present invention, there is provided a risen bread product comprising oat flakes, hull-less oats, psyllium husks, salt and water, wherein said bread product is free of any exogenously added leavening agent.

In another aspect of the present invention, there is provided a risen bread product consisting of oat flakes, hull-less oats, psyllium husks, salt and water.

### BRIEF DESCRIPTION OF THE DRAWINGS

These and other features of the invention will become more apparent in the following detailed description in which reference is made to the appended drawing.

FIG. 1 provides photographs of the oat bread before (left side) and after baking (right side).

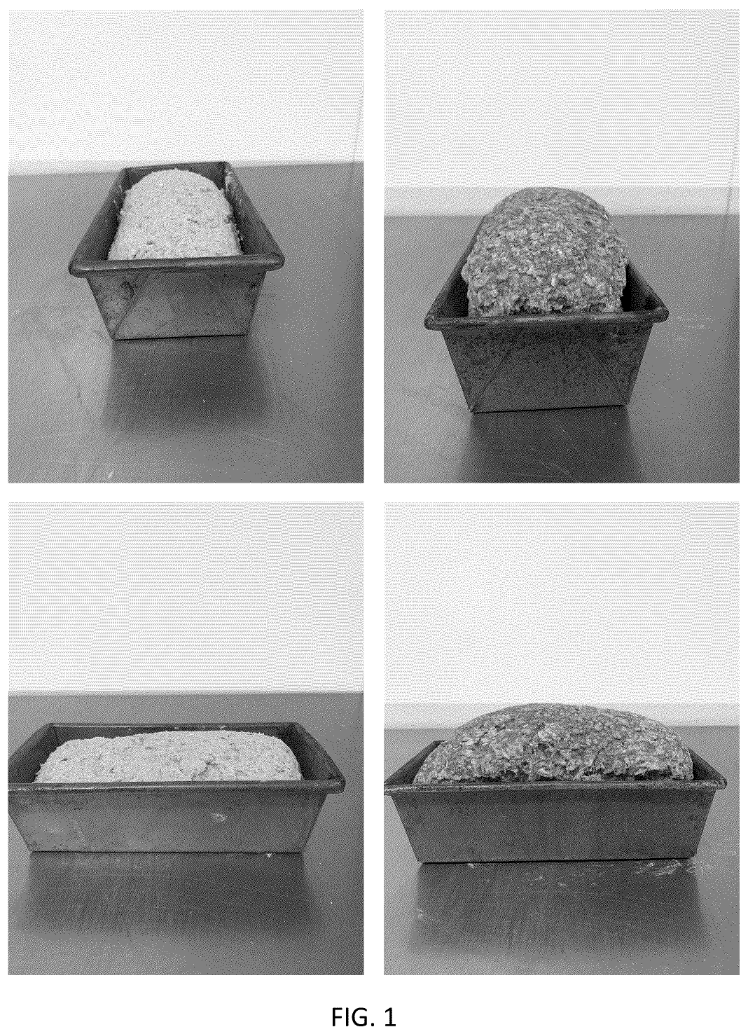

FIG. 2. Provides a photograph of a slice of the baked oat bread showing the crumb structure.

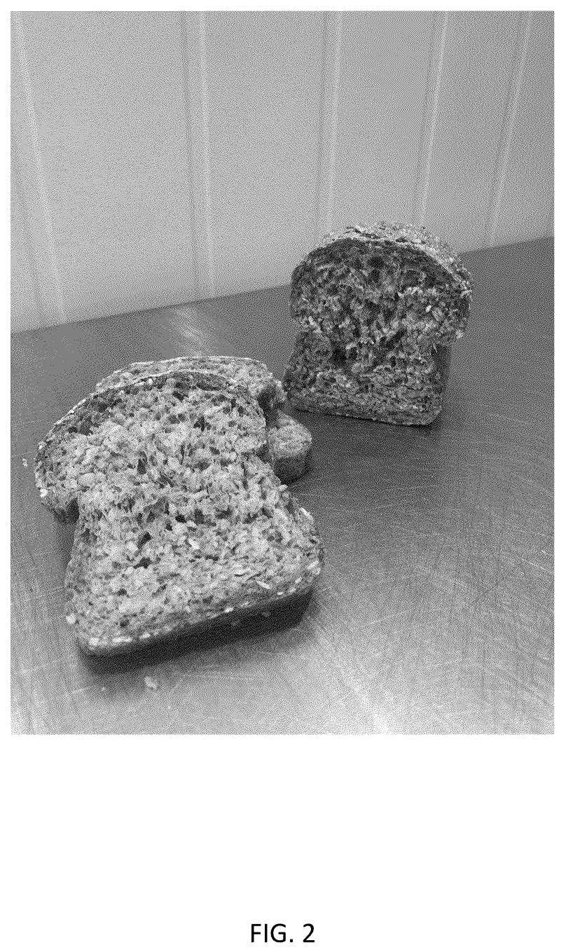

### DETAILED DESCRIPTION OF THE INVENTION

The present invention is based on the discovery that bread products produced using a combination of flaked oats with hull (herein referred to as “flaked oats”) and hull-less flaked oats (herein referred to as “hull-less” oats) exhibit self-rising behaviour. This self-rising behaviour is not observed using oat flour, buckwheat, millet, sorghum, and wheat flour. The self-rising behaviour is observed with a variety of ratios flaked oats to hull-less oats. In particular, comparable rising is observed with the following ratios (% by weight) of flaked to hull-less oats 15:85, 20:80, 30:70, 40:60, 50:50, 60:40, 70:30 and 80:20. Very little or no rise is observed when above 85% hull-less oats is used and use of above 80% flaked oats results in too much rise (hollow with very little crumb structure).

Accordingly, the present invention provides a method of manufacturing oat bread without the addition of exogenous leavening agents, such as yeast or baking powder and bread products produced by the method. In certain embodiments, the method does not include a proofing stage and rising occurs during baking. In specific embodiments, the present invention provides a method of manufacturing a heat-activated self-rising oat bread and bread products produced by the method. The method may permit high throughput production with machine-assist.

The method may utilize gluten-free ingredients. Accordingly, in certain embodiments, there is provided a method of manufacturing a gluten-free, self-rising oat bread and gluten free bread products produced by the method. In certain embodiments, no animal products are utilized in the manufacture. Accordingly, in such embodiments, the products produced are vegan.

### Method

The present invention provides a method of manufacturing one or more bread products, the method comprising: mixing oat flakes, hull-less oats, a soluble fiber such as psyllium husks, salt and water to produce a dough; shaping the dough into one or more bread products; and baking the bread products. Additional ingredients such as spices (e.g. cinnamon), dried fruit (such as raisins) orange pieces, ginger and/or chocolate chips may also be added.

The oat flakes, hull-less oats, psyllium husks, salt and water are mixed for a pre-determined amount of time to produce a dough. In certain embodiments, the ingredients are provided in the following ratios:

| Ingredients | Percentage out 100% by weight of total ingredients |
|---|---|
| Flaked Oats | about 6-8% |
| Hull-less Oats | about 34-36% |
| Psylium husk | about 2.5-4% |
| Salt | about 0.5-1.5% |
| Water | About 50-60% |

In specific embodiments, for a 101.1 KG batch, the ingredients are provided in the following amounts:

| Ingredients | Weight (±10%) | |
|---|---|---|
| Flaked Oats | 6.995 | KG |
| Hull-less Oats | 34.974 | KG |
| Psylium husk | 3.352 | KG |
| Salt | 0.767 | KG |
| water | 55.033 | KG |

In certain embodiments, the dry ingredients are mixed prior to addition of the water. In certain embodiments, the dry ingredients are mixed for approximately 5 to 10 minutes prior to the addition of water. In specific embodiments, the dry ingredients are mixed for about 5 minutes prior to the addition of water.

Water is added to the dry ingredients and mixed to form a dough. In certain embodiments, the dry ingredients and water are mixed for approximately 10-15 minutes. In specific embodiments, the dry ingredients and water are mixed for about 12 minutes.

The formed dough is shaped into one or more bread products, including loaves and/or buns (including but not limited to round buns, triangular buns, bagels and ciabatta. In certain embodiments, the dough is formed into bagels.

The bread products are then baked. In certain embodiments, the bread products are fully baked. In certain embodiments, the bread products are baked at 200-225° C. until fully baked. In specific embodiments, the bread products are baked at about 210° C. until fully baked. A worker skilled in the art could determine the amount of time required to bake the bread product. In certain embodiments where the bread product is a bagel, the bagel is optionally boiled before baking.

### Bread Products

The present invention also provided oat bread products. In certain embodiments, the oat bread products are free of exogenously added leavening agents, such as yeast or baking powders. In specific embodiments, the bread products are self-rising oat bread products. In more specific embodiments, the bread products are heat-activated self-rising oat bread products. Exemplary bread products include but are not limited to loaves and buns.

In certain embodiments, the risen bread product comprises/consists of oat flakes, hull-less oats, a soluble fiber such as psyllium husks, salt and water, wherein said bread product is free of any exogenously added leavening agent. Additional ingredients such as spices (e.g. cinnamon), dried fruit (such as raisins) orange pieces, ginger and/or chocolate chips may also be added.

In certain embodiments, the oat bread products are gluten free and/or vegan.

### Example

### Purpose

The example below describes a heat-activated self-rising oat bread (buns and loaves) manufacturing procedure.
a. INGREDIENTS
   i. Avena Gluten-free Oat flakes
   ii. Hull-less Oats (locally grown)
   iii. Psyllium husk
   iv. Salt
b. EQUIPMENT
   i. Cinelli 100 kg Spiral Mixer
   ii. VEMAG dough portioning robot
   iii. Work bench
   iv. Scoops (500 g-2 KG)
   v. Wet and dry measuring containers (10-20 KG)
   vi. Bench Scale (up to 60 lbs)
   vii. 12.5 gallon food-grade food bins for dough storage post-mixing
   viii. Bakery racks
   ix. Perforated baking trays (16″×24″)
c. RECIPE: Plain Oat Dough (101.1 KG batch)
   i. 6.995 kg Avena Flaked Oats
   ii. 34.974 KG Hull-less Oats (AAC Nitro/AAC Gehl)
   iii. 3.352 KG Psyllium husk
   iv. 0.767 KG Salt
   v. 55.033 KG Water
d. METHODOLOGY
   i. Preparation
      1. Preheat oven to 210° C.
      2. Measure dry ingredients using measuring containers, scoops and scale.
      3. Add dry ingredients to mixer and premix for 5 minutes to fully mix and incorporate dry ingredients.
      4. Measure water.
   ii. Mixing
      1. Add water to dry ingredients in mixing bowl.
      2. Start mixer and ensure all ingredients are incorporated and no dry ingredients remain.
      3. Mix 12 minutes.
   iii. Dough Dividing (VEMAG)
      1. The automated dough divider should be adjusted to produce 600 g portions of dough having an oblong or rectangular shape with an approximate length of 8 inches and 2.5 inches high.
   iv. Baking
      1. Bake at ˜210° C. for 130 minutes.
   v. Post-baking
      1. Allow loaves to partially cool, remove from pans and allow to reach room temperatures (approximately 1.5 hours).
      2. Package, store or freeze.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

We claim:

1. A method of manufacturing one or more self-rising oat bread products, the method comprising:
a) mixing oat flakes, hull-less oats, psyllium husks and salt to produce a mixture of dry ingredients;
b) adding water to the dry ingredients and mixing to produce a dough;
c) shaping the dough into one or more bread products; and
d) baking the bread products.

2. The method of claim 1, wherein the range of ratios of oat flakes to hull-less oats (% by weight) of flaked to hull-less oats 15:85 to 80:20.

3. The method of claim 1, wherein in step a), mixing is for about 5 to about 10 minutes.

4. The method of claim 1, wherein in step b) the mixing to produce a dough is for about 12 minutes.

5. The method of claim 1, wherein the baking is at about 210° C.

6. A risen bread product produced by the method of claim 1.

7. A risen bread product comprising oat flakes, hull-less oats, psyllium husks, salt and water, wherein said bread product is free of any exogenously added leavening agent.

8. A risen bread product consisting of oat flakes, hull-less oats, psyllium husks, salt and water.
